(19) United States
(12) Patent Application Publication
(10) Pub. No.: US 2014/0328436 A1
(43) Pub. Date: Nov. 6, 2014

(54) RECEIVER FRONT-END ARCHITECTURE FOR CARRIER AGGREGATION

(71) Applicant: NVIDIA CORPORATION, Santa Clara, CA (US)

(72) Inventors: Abdellatif Bellaouar, Richardson, TX (US); Frank Zhang, Richardson, TX (US); Essam Atalla, Richardson, TX (US)

(73) Assignee: Nvidia Corporation, Santa Clara, CA (US)

(21) Appl. No.: 13/886,310

(22) Filed: May 3, 2013

(51) Int. Cl. H04L 27/00; H04L 27/26

(52) U.S. Cl. CPC H04L 27/0002; H04L 27/2649
USPC 375/340

(57) ABSTRACT

A receiver front-end includes a receive path configured to receive an input signal. Additionally, the receiver front-end also includes a low noise amplifier having a common input stage and multiple separate output stages, wherein each separate output stage is configured to be separately activated and connected to a receive signal mixer that provides signal demodulation of the input signal employing one of an aggregation of receiver carriers. A method of operating a receiver front-end and a receiver front-end system are also provided.

### TECHNICAL FIELD

This application is directed, in general, to communication systems and, more specifically, to a receiver front-end, a method of operating a receiver front-end and a receiver front-end system.

### BACKGROUND

Carrier aggregation is one of the main features of LTE-advanced implementation. Carrier aggregation of two component carriers permits support of wider transmission bandwidths. For example, LTE-advanced applications permit a maximum carrier aggregation of 40 MHz (two 20 MHz bandwidths employing two carriers). Currently, carrier aggregation using two carriers requires two receiver paths, where each is dedicated to a separate carrier. This architecture solves the inter-band implementation issue. However for intra-band applications, it is not efficient since each path is required to duplicate a duplexer, matching network and low noise amplifier for the same band. Moreover, this architecture is not very flexible in supporting multiple bands, since each path requires different demodulating oscillators (e.g., different phase-locked loops). Therefore, an improvement in receiver front-end architecture to support both inter-band and intra-band without intra-band hardware duplication would prove beneficial to the art.

### SUMMARY

Embodiments of the present disclosure provide a receiver front-end, a method of operating a receiver front-end and a receiver front-end system.

In one embodiment, the receiver front-end includes a receive path configured to receive an input signal. Additionally, the receiver front-end also includes a low noise amplifier having a common input stage and multiple separate output stages, wherein each separate output stage is configured to be separately activated and connected to a receive signal mixer that provides signal demodulation of the input signal employing one of an aggregation of receiver carriers.

In another aspect, the method of operating a receiver front-end includes receiving input signals corresponding to an aggregation of carriers. The method of operating a receiver front-end also includes providing input signal amplification having a common input and multiple separate outputs, wherein each output is capable of being separately activated to demodulate one of the input signals employing one of the aggregation of receiver carriers.

In yet another aspect, the receiver front-end system includes a plurality of receive signal paths having receive signals corresponding to an aggregation of receiver carriers. The receiver front-end system also includes a corresponding plurality of low noise amplifiers each having a common input stage and multiple separate output stages, wherein each multiple separate output stage is capable of separate activation and connection to a receive signal mixer that provides demodulation of one of the receive signals employing one of the aggregation of receiver carriers.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

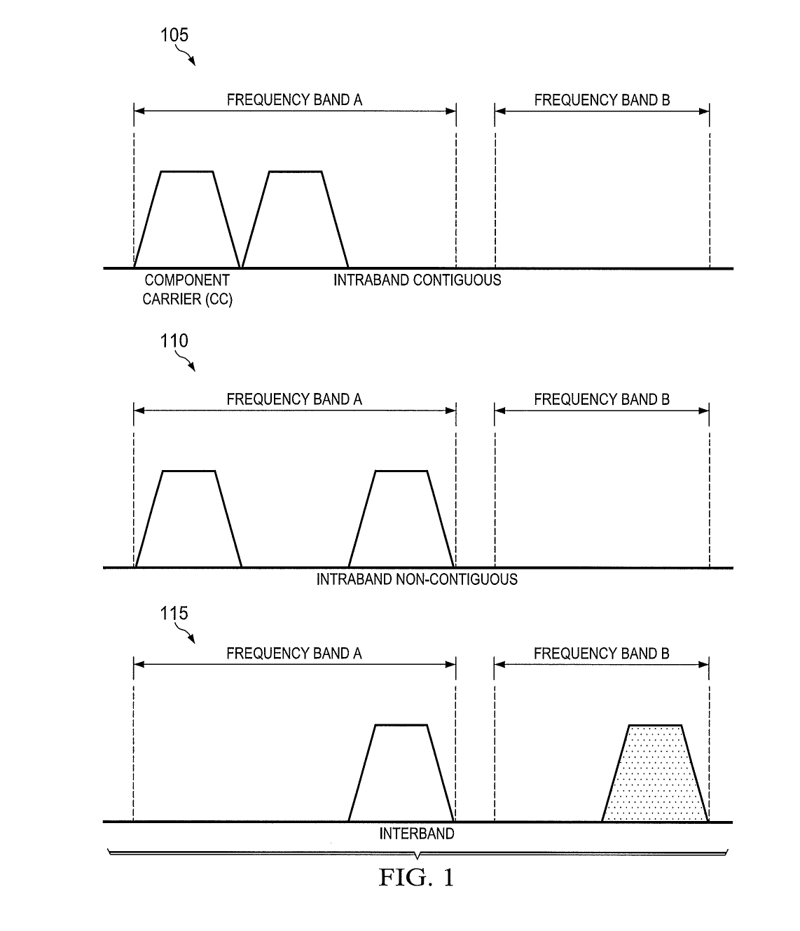

FIG. 1 illustrates various carrier aggregation modes, generally designated 105, 110 and 115, employing first and second frequency bands A and B as may be employed in a receiver.

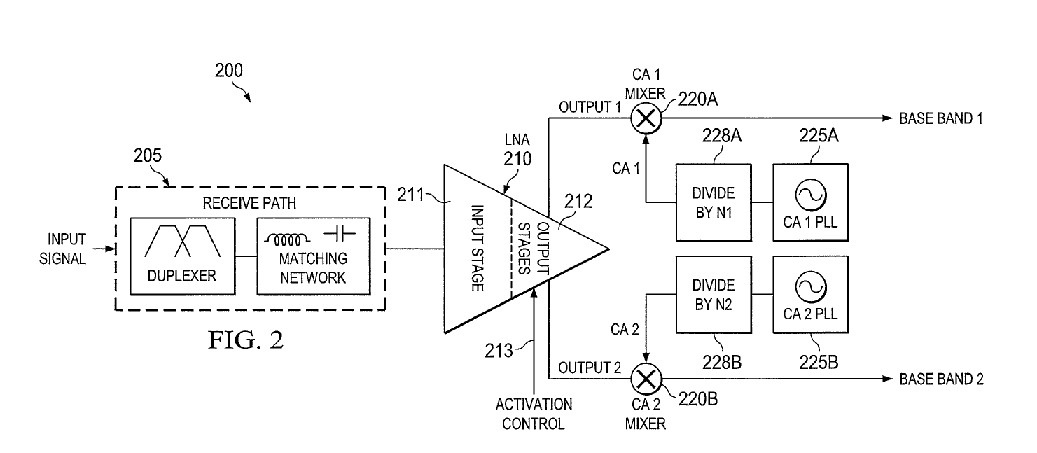

FIG. 2 illustrates a block diagram of an embodiment of a receiver front-end for carrier aggregation constructed according to the principles of the present disclosure;

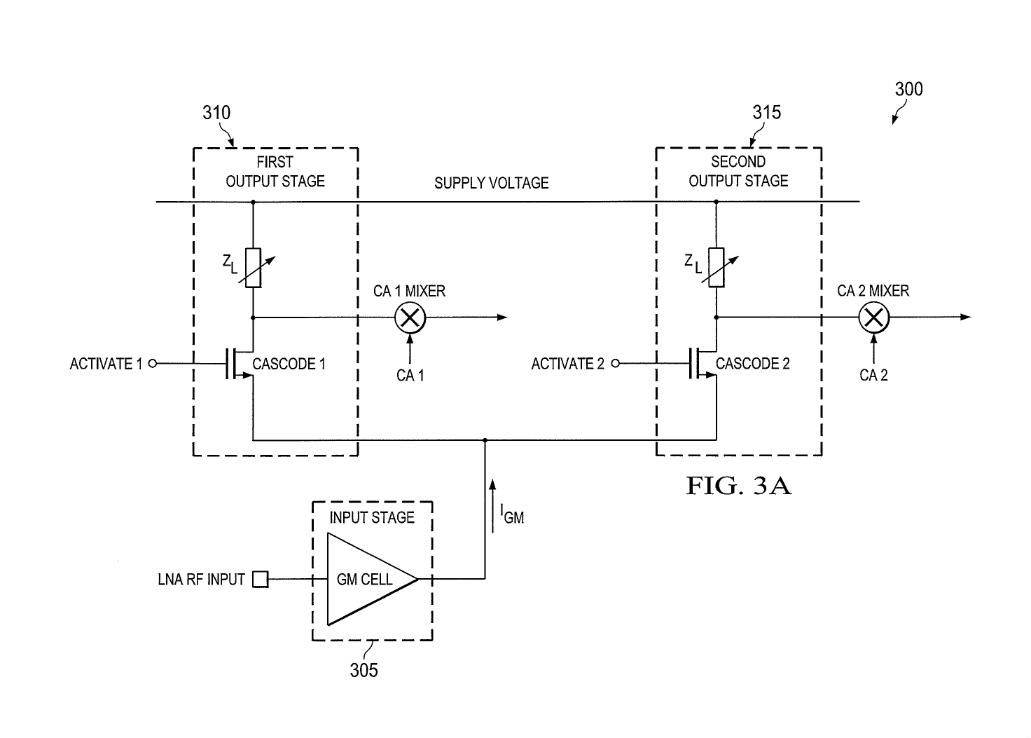

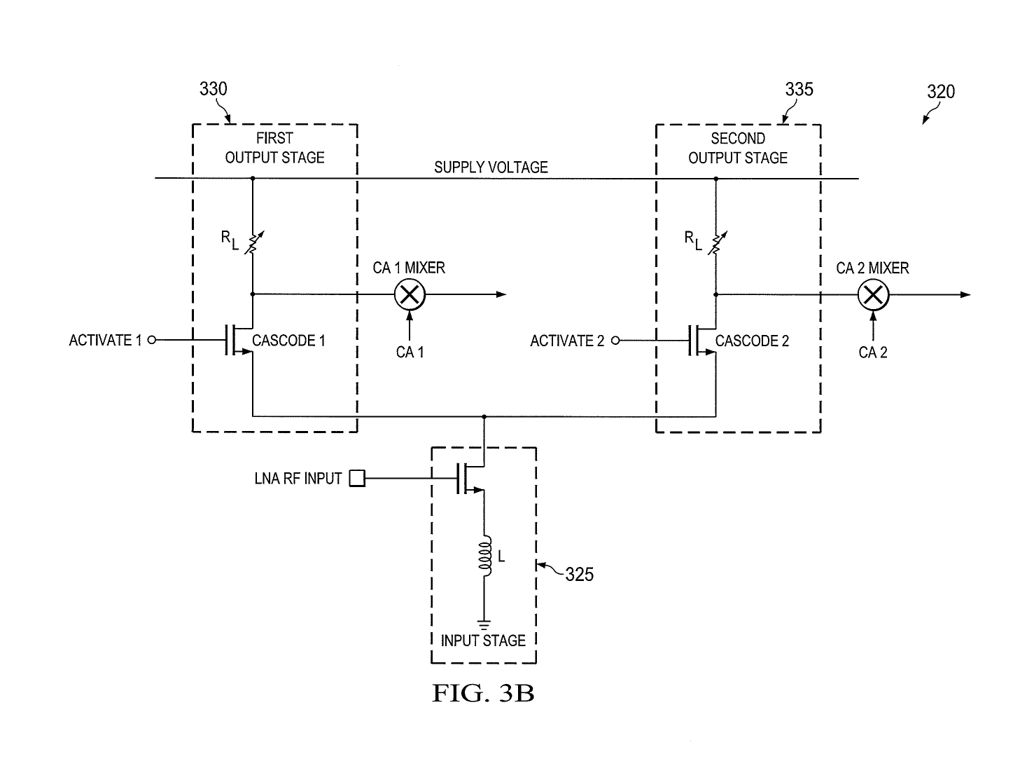

FIGS. 3A, 3B illustrate schematic examples of a low noise amplifier constructed according to principles of the present disclosure;

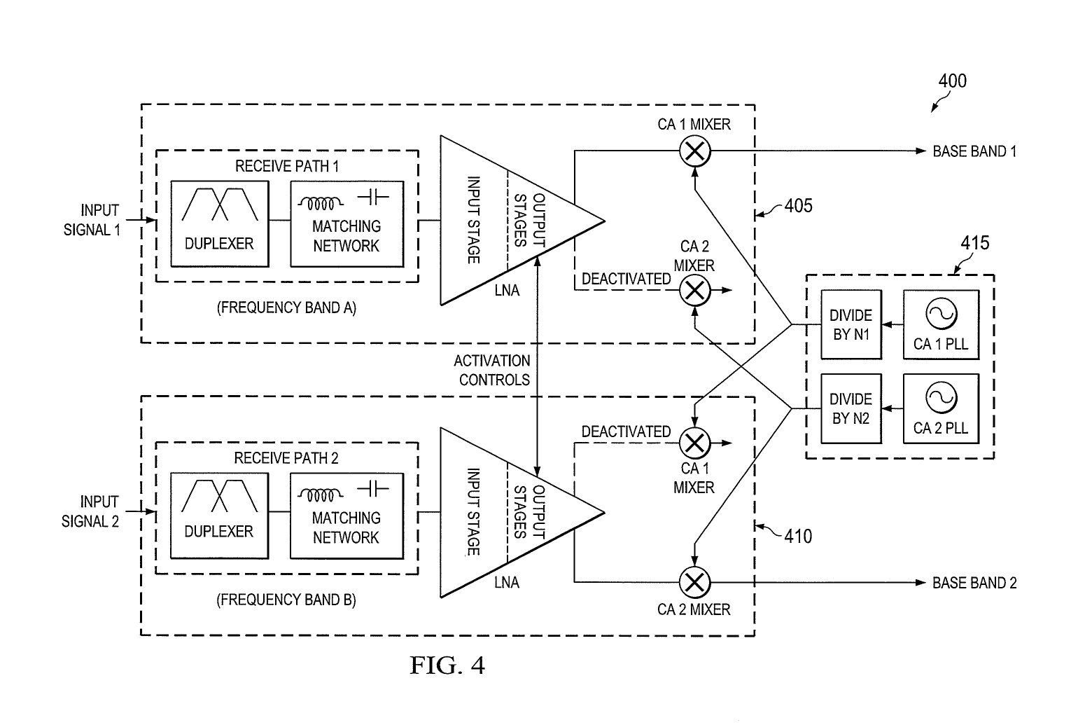

FIG. 4 illustrates a block diagram of an embodiment of a receiver front-end system for carrier aggregation constructed according to the principles of the present disclosure;

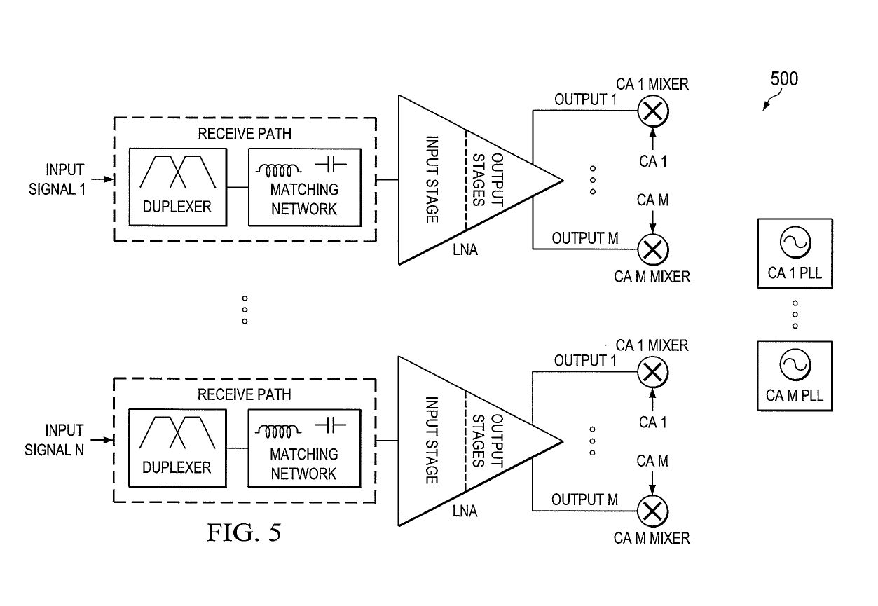

FIG. 5 illustrates an embodiment of another receiver front-end system constructed according to the principles of the present disclosure; and

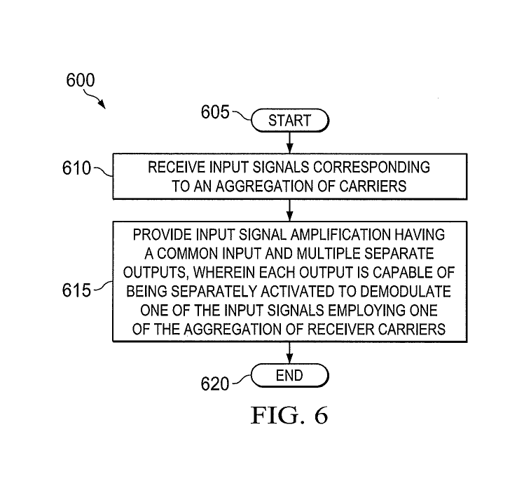

FIG. 6 illustrates a flow diagram of an embodiment of a method of operating a receiver front-end carried out according to the principles of the present disclosure.

### DETAILED DESCRIPTION

Various carrier aggregation modes, generally designated 105, 110 and 115, employing first and second frequency bands A and B as may be employed in a receiver are shown in FIG. 1. Carrier aggregation mode 105 shows two intra-band, contiguous component carriers in frequency band A and no carriers in frequency band B. Carrier aggregation mode 110 shows two intra-band, non-contiguous carriers in frequency band A and no carriers in frequency band B. Carrier aggregation mode 115 shows two inter-band carriers in frequency bands A and B, since inter-band carriers are always located in different frequency bands.

Embodiments of the present disclosure employ a novel receiver front-end building block to efficiently accommodate these carrier aggregation modes. These embodiments are often illustrated in the following discussions employing only two frequency bands for simplicity of discussion. However, embodiments of the present disclosure are applicable to a multiplicity of frequency bands greater than two. Although single-ended signal applications are also shown for simplicity, differential signals as well as IQ modulation applications are also supported by the principles of the present disclosure.

Additionally, the novel receiver front-end building block includes a low noise amplifier having a common input stage and multiple separate output stages, wherein each separate output stage is configured to be separately activated (i.e., independently activated) and connected to a receive signal mixer that provides signal demodulation of an input signal employing one of an aggregation of receiver carriers. For the case of intra-band signals, all of the multiple separate output stages of each low noise amplifier employed are typically activated. For the case of inter-band signals, only one of the multiple separate output stages of each low noise amplifier employed is typically activated.

FIG. 2 illustrates a block diagram of an embodiment of a receiver front-end for carrier aggregation, generally designated 200, constructed according to the principles of the present disclosure. The receiver front-end 200 is for use in receiving intra-band signal applications, wherein contiguous or non-contiguous intra-band carriers may be employed as was illustrated in the carrier aggregation modes 105, 110 of FIG. 1. Although the receiver front-end 200 is shown for only two frequency bands, the receiver front-end 200 may be expanded to accommodate a greater number of frequency bands. Additionally, each of these carriers may employ different bandwidths (e.g., 1.4, 3, 5, 10, 15 and 20 MHz, in one example).

The receiver front-end 200 includes a receive path 205, a low noise amplifier (LNA) 210, a first carrier mixer (CA1 MIXER) 220A, a second carrier mixer (CA2 MIXER) 220B, a first carrier phase-locked loop (CA1 PLL) 225A having a first divider stage 228A and a second carrier phase-locked loop (CA2 PLL) 225B having a second divider stage 228B. The receive path 205 includes a duplexer and a matching network, as shown. The LNA 210 includes an input stage 211 and multiple separate output stages 212 (i.e., first and second output stages in this example) whose activation is determined by an activation control signal 213.

Generally, a receive signal is conditioned by the receive path 205 and amplified by the LNA 210. The input stage 211 and both of the first and second output stages (corresponding to the multiple separate output stages 212) are activated and employed in this intra-band signal application. Alternatively, only one of the first or second output stages is activated and employed for an inter-band signal application.

The first output stage provides a first output (OUTPUT 1) to the first carrier mixer (CA1 MIXER) 220A that is demodulated by a first receive carrier CA1 (corresponding to a first frequency band) into a first baseband signal (BASEBAND 1). Similarly, the second output stage provides a second output (OUTPUT 2) to the second carrier mixer (CA2 MIXER) 220B that is demodulated by a second receive carrier CA2 (corresponding to a second frequency band) into a second baseband signal (BASEBAND 2).

The first receive carrier CA1 is provided by the first carrier phase-locked loop (CA1 PLL) 225A and the first divider stage 228A, and the second receive carrier CA2 is provided by the second carrier phase-locked loop (CA2 PLL) 225B and the second divider stage 228B. The first receive carrier CA1 is generated by a first voltage controlled oscillator (VCO1) in the CA1 PLL 225A, where a frequency of the VCO1 is divided by N1 in the first divider stage 228A. Similarly, the second receive carrier CA2 is generated by a second voltage controlled oscillator (VCO2) in the CA2 PLL 225B, where a frequency of the VCO2 is divided by N2 in the second divider stage 228B. For smaller bandwidths and in order to avoid “pulling” between VCO1 and VCO2 frequencies, N1 is different than N2. For example, for a small bandwidth case, N1 can be four and N2 can be eight. Other combinations of N1 and N2 are possible depending on bandwidth frequencies.

FIGS. 3A, 3B illustrate schematic examples of a low noise amplifier, generally designated 300, 320, constructed according to principles of the present disclosure.

The LNA 300 includes an input stage 305 and multiple separate output stages 310, 315 (i.e., two separate output stages in this example). In this implementation, the input stage 305 is composed of a transconductance (Gm) cell, which may be a common source or common gate arrangement. The Gm cell provides an output current I_{Gm} that is proportional to its input voltage (LNA RF input). The multiple separate output stages 310, 315 are composed of a cascode device and a load. The load can be resistive or inductive and is used to vary the gain of its output stage. This architecture helps to reduce any cross-talk between the two outputs due to the higher output impedances of the cascode devices and the Gm cell 305. The output stages 310, 315 are activated when the cascode devices are placed in a conducting condition by the first or second activation signals (ACTIVATE 1, ACTIVATE 2).

The LNA 320 includes an input stage 325 and multiple separate output stages 330, 335 (again, corresponding to only two separate output stages). Generally, operation of the input stage 325 and output stages 330, 335 parallel those of the LNA 300. However, in this implementation, the input stage 325 employs a common source arrangement using inductor degeneration, and gains of the first and second output stages 330, 335 are controlled by programmable resistors. Again, any cross-talk between the two outputs is diminished due to the higher output impedances of the cascode devices and the input stage 325.

FIG. 4 illustrates a block diagram of an embodiment of a receiver front-end system for carrier aggregation, generally designated 400, constructed according to the principles of the present disclosure. The receiver front-end system 400 employs the same architecture as shown in FIG. 2 and is for use in receiving inter-band signal applications, wherein only two frequency bands are employed, as shown in FIG. 1. As noted previously, only one output stage of each LNA is activated and employed for this inter-band signal application. Again, the principles of the present disclosure may be applied to a multiplicity of frequency bands that is greater than two.

The receiver front-end system 400 includes first and second receiver front-ends 405, 410, which are each portions of the receiver front-end that was discussed with respect to FIG. 2. Additionally, the receiver front-end 400 system also includes a shared carrier generator 415 that includes a first carrier phase-locked loop (CA1 PLL) employing a first divider stage and a second carrier phase-locked loop (CA2 PLL) employing a second divider stage.

Here, each receiver path is assigned to a specific band. In the illustrated embodiment, the first receiver front-end 405 processes a first frequency band (e.g., the first frequency band A of FIG. 1), and the second receiver front-end 410 processes a second frequency band (e.g., the second frequency band B of FIG. 1). Additionally, each LNA has two mixers driven by both PLLs. However, only one mixer is activated for each path, as shown. The first receiver front-end 405 is activated to use only the CA1 MIXER, and the second receiver front-end 410 is activated to use only the CA2 MIXER, as shown. Still, N1 can be different from N2 to avoid any pulling mechanism between the two bands.

FIG. 5 illustrates an embodiment of another receiver front-end system, generally designated 500, constructed according to the principles of the present disclosure. The receiver front-end system 500 is a general receiver front-end system and includes a plurality of N receive signal paths having N receive signals corresponding to an aggregation of M receiver carriers. The receiver front-end system 500 also includes a corresponding plurality of N low noise amplifiers, each having a common input stage and M multiple separate output stages. Here, each of the M multiple separate output stages is capable of separate activation and respective connection to one of M receive signal mixers to provide demodulation of a corresponding one of the N receive signals employing one of the aggregation of M receiver carriers. The receiver front-end system 500 further includes M multiple PLLs that correspondingly provide the M receiver carriers to the M receive signal mixers.

FIG. 6 illustrates a flow diagram of an embodiment of a method of operating a receiver front-end, generally designated 600, carried out according to the principles of the present disclosure. The method 600 starts in a step 605, and input signals corresponding to an aggregation of carriers are received, in a step 610. Then, input signal amplification is provided having a common input and multiple separate outputs, wherein each output is capable of being separately activated to demodulate one of the input signals employing one of the aggregation of receiver carriers, in a step 615.

In one embodiment, providing the input signal amplification includes providing low noise signal amplification. In another embodiment, each of the multiple separate outputs provides signal feedback isolation from the remaining outputs. In yet another embodiment, receiving the input signals and providing the input signal amplification includes processing a single-ended signal, a differential signal or an IQ modulated signal.

In still another embodiment, the aggregation of receiver carriers includes carriers corresponding to intra-band signals or inter-band signals. In a further embodiment, at least a portion of the multiple separate outputs is activated for processing intra-band signals. In a yet further embodiment, only one of the multiple separate outputs is activated for processing an inter-band signal. The method 600 ends in a step 620.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A receiver front-end, comprising:
a receive path configured to receive an input signal; and
a low noise amplifier having a common input stage and multiple separate output stages, wherein each separate output stage is configured to be separately activated and connected to a receive signal mixer that provides signal demodulation of the input signal employing one of an aggregation of receiver carriers.

2. The receiver front-end as recited in claim 1 wherein the receive path includes a duplexer and a matching network.

3. The receiver front-end as recited in claim 1 wherein each of the multiple separate output stages provides signal feedback isolation from the remaining output stages.

4. The receiver front-end as recited in claim 1 wherein the aggregation of receiver carriers includes carriers corresponding to intra-band signals or inter-band signals.

5. The receiver front-end as recited in claim 1 wherein at least a portion of the multiple separate output stages are activated for processing intra-band signals.

6. The receiver front-end as recited in claim 1 wherein only one of the multiple separate output stages is activated for processing an inter-band signal.

7. The receiver front-end as recited in claim 1 wherein the receive path and low noise amplifier are configured to process a single-ended signal, a differential signal or an IQ modulated signal.

8. A method of operating a receiver front-end, comprising:
receiving input signals corresponding to an aggregation of carriers; and
providing input signal amplification having a common input and multiple separate outputs, wherein each output is capable of being separately activated to demodulate one of the input signals employing one of the aggregation of receiver carriers.

9. The method as recited in claim 8 wherein providing the input signal amplification includes providing low noise signal amplification.

10. The method as recited in claim 8 wherein each of the multiple separate outputs provides signal feedback isolation from the remaining outputs.

11. The method as recited in claim 8 wherein the aggregation of receiver carriers includes carriers corresponding to intra-band signals or inter-band signals.

12. The method as recited in claim 8 wherein at least a portion of the multiple separate outputs is activated for processing intra-band signals.

13. The method as recited in claim 8 wherein only one of the multiple separate outputs is activated for processing an inter-band signal.

14. The method as recited in claim 8 wherein receiving the input signals and providing the input signal amplification includes processing a single-ended signal, a differential signal or an IQ modulated signal.

15. A receiver front-end system, comprising:
a plurality of receive signal paths having receive signals corresponding to an aggregation of receiver carriers; and
a corresponding plurality of low noise amplifiers each having a common input stage and multiple separate output stages, wherein each multiple separate output stage is capable of separate activation and connection to a receive signal mixer that provides demodulation of one of the receive signals employing one of the aggregation of receiver carriers.

16. The system as recited in claim 15 wherein each of the multiple separate output stages provides signal feedback isolation from the remaining output stages.

17. The system as recited in claim 15 wherein the aggregation of receiver carriers includes carriers corresponding to intra-band signals or inter-band signals.

18. The system as recited in claim 15 wherein at least a portion of the multiple separate output stages are activated for processing intra-band signals.

19. The system as recited in claim 15 wherein only one of the multiple separate output stages is activated for processing an inter-band signal.

20. The system as recited in claim 15 wherein the receive path and low noise amplifier are configured to process a single-ended input signal or a differential input signal.
